(19) United States
(12) Patent Application Publication
(10) Pub. No.: US 2026/0301768 A1
(43) Pub. Date: Oct. 1, 2026

(54) HARD DISK DRIVE (HDD) COMPONENTS FORMED OF AN ALLOY, AND RELATED HDDs AND METHODS

(71) Applicant: Seagate Technology LLC, Fremont, CA (US)

(72) Inventors: Michael Yi Zhao YAO, Singapore (SG); Daniel Raymond Stevens, Longmont, CO (US); Tsuny Ming Boh, Singapore (SG)

(21) Appl. No.: 19/093,555

(22) Filed: Mar. 28, 2025

(51) Int. Cl. G11B 5/706; C22C 38/10

(52) U.S. Cl. CPC G11B 5/70615; C22C 38/105

(57) ABSTRACT

A hard disk drive (HDD) using magnetic recording includes one or more components that directly contact the recording media. Such direct contact HDD components can be formed from an alloy including iron and at least one non-iron metal, such as nickel, cobalt or chromium. The recording media can be formed from a material having a low coefficient of thermal expansion (CTE), such as borosilicate glass. Forming the HDD components from the iron alloy, which also has a low CTE, makes the HDD components well suited for use with the low CTE recording media because the difference in CTE values is within an acceptable range, thus avoiding or minimizing any distortion to the media. The HDD components can include a disk spacer, a motor hub or a disk clamp.

### BACKGROUND

The present disclosure relates to hard disk drives (HDD) that use magnetic recording to write data to and read data from a media disk. One or more components of an HDD having direct contact with the media disk (also referred to as media platter or recording disk) can cause media to distort to an undue degree if such a component has a coefficient of thermal expansion (CTE) that is not suitably matched to the media disk.

There is a continuing need to form the HDD components from materials having a CTE within an acceptable range of a CTE of the media disk used in the HDD.

### SUMMARY

The present disclosure includes embodiments of a hard disk drive that includes a spindle motor having a motor hub, a plurality of recording disks arranged in a stack and rotatably mounted on the motor hub, a spacer disposed between a pair of recording disks in the plurality of recording disks, and a disk clamp configured to attach to the motor hub such that the plurality of recording disks are secured to the hard disk drive. At least two of the motor hub, the spacer, and the disk clamp are made of an iron alloy. The iron alloy includes iron and at least one non-iron metal constituent selected from nickel, cobalt and chromium.

The present disclosure includes embodiments of a component configured to be positioned in a hard disk drive to directly contact a recording disk. The component is formed of at least one of a first ternary alloy of iron-nickel-cobalt and a second ternary alloy of cobalt-iron-chromium. The component can be a motor hub, a spacer, a disk clamp, or combinations thereof.

The present disclosure includes embodiments of a method for assembling a hard disk drive. The method includes providing a spindle motor that attaches to a base of the hard disk drive, the spindle motor including a motor hub, and mounting a plurality of disks onto the motor hub in a stacked configuration. The motor hub is configured to be received through an opening of each disk of the plurality of disks to mount the plurality of disks onto the motor hub. The plurality of disks are configured to rotate around the motor hub. The method includes placing an annular spacer between an adjacent pair of disks in the plurality of disks and attaching a disk clamp to the motor hub to secure the plurality of disks within the hard disk drive. At least two of the motor hub, the annular spacer and the disk clamp are formed from an iron alloy comprising at least one of nickel, cobalt and chromium.

### BRIEF DESCRIPTION OF THE DRAWINGS

The discussion below references the following figures, wherein the same reference number may be used to identify the similar/same component in multiple figures. The schematic figures are for illustration purposes and are not necessarily drawn to scale.

FIG. 1 is an exploded view of a hard disk drive (HDD), in accordance with embodiments described herein.

FIG. 2 is a perspective view of a disk spacer (or spacer ring) of the HDD of FIG. 1, in accordance with embodiments described herein.

FIG. 3 is a perspective view of a motor hub of the HDD of FIG. 1, in accordance with embodiments described herein.

FIG. 4 is a perspective view of a disk clamp (or top clamp) of the HDD of FIG. 1, in accordance with embodiments described herein.

### DETAILED DESCRIPTION

The present disclosure relates to a component configured to be positioned in a hard disk drive (HDD) to directly contact a recording disk (or media disk). Non-limiting examples of such HDD components having direct contact with the media disk include the motor hub, disk spacer, and/or disk clamp. Such direct contact HDD components can be formed from an alloy including iron and at least one non-iron metal, such as nickel, cobalt or chromium. The specialty iron alloys disclosed herein have a low coefficient of thermal expansion (CTE) such that the iron alloys are well suited for use with one or more HDD components when a substrate for the recording disk has a relatively low CTE.

The coefficient of thermal expansion (CTE) refers to how much a material (or combination of two or more materials) changes in size with a change in temperature. In other words, CTE quantifies the fractional change in size—a fractional increase in length per unit rise in temperature. A material or material combination with a low CTE has a lower propensity for a change in size due to temperature changes, relative to a material or material combination with a high CTE.

The low expansion/iron alloys disclosed herein include iron and at least one of nickel, cobalt, and chromium. In an example, the iron alloy is a binary iron-nickel alloy. In an example, the iron alloy is a ternary alloy formed of iron and two other non-iron metal constituents. Examples of ternary alloys include, but are not limited to, iron-nickel-cobalt, iron-nickel-chromium, and iron-cobalt-chromium (cobalt-iron-chromium). For purposes of the present disclosure, the terms “specialty alloy”, “iron alloy” and “low expansion alloy” can refer to an alloy comprising iron and at least one other non-iron metal constituent. For purposes of the present disclosure, the alloys disclosed herein can be referred to as iron alloys even for specific alloy compositions in which iron is not the highest percent constituent in the alloy composition.

For purposes of this disclosure, a metal is considered a “constituent” of the low-expansion alloy composition if an amount of the metal in the alloy composition is at least 1.0 percent by weight. Such metal can also be referred to herein as a primary element or an active element in the low expansion alloy composition. If the amount of the metal in the alloy composition is less than about 1.0 percent by weight, the metal is considered negligible or an impurity of the alloy composition. It is recognized that the alloy composition may also contain non-metals at less than about 1.0 weight percent and those non-metals would be also be considered negligible or an impurity.

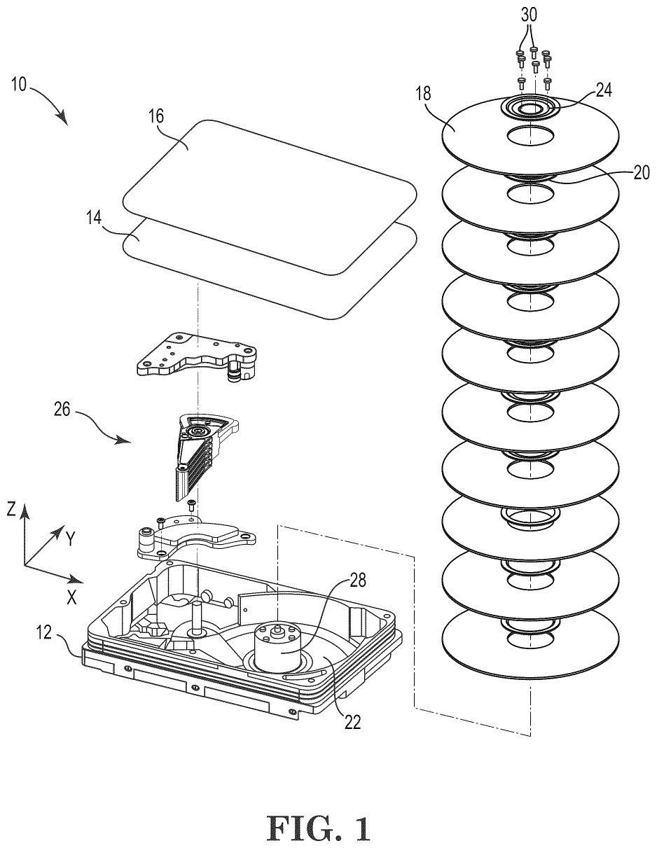

FIG. 1 shows an exploded view of a hard disk drive (HDD) 10, which can include a base deck 12, a process cover 14, and a top cover 16. The process cover 14 can be coupled to the base deck 12 to create an internal cavity that houses data storage components including a plurality of magnetic recording media 18, a plurality of disk spacers 20, a spindle motor 22, a disk clamp 24, and an actuator assembly 26.

The spindle motor 22 can include a motor hub 28 that receives the magnetic recording media 18 such that the media/disks 18 are arranged in a stacked configuration and rotatably mounted on the motor hub 28. A disk spacer 20 is positioned between each adjacent pair of recording media/disks 18 in the stack. Thus, the number of disk spacers 20 is dependent on the number of the recording disks 18.

Once the stack of disks 18 is assembled on the motor hub 28, the disk clamp 24 can attach to the motor hub 28 such that the disks 18 are secured in the HDD 10. The disk clamp 24 can include fasteners 30 for attaching to the motor hub 28.

Ten recording media/disks 18 are shown in the exemplary HDD 10 of FIG. 1. It is recognized that the HDD 10 can include more or less than ten disks. In some embodiments, the number of disks 18 in the HDD 10 is selected based on the data storage capacity of the HDD 10.

The disk 18 can include a substrate and a plurality of layers that, together, form the disk 18. Non-limiting examples of the layers include one or more of a seed layer, a soft magnetic underlayer, an interlayer, a magnetic recording layer, an overcoat, a lubricant, and the like.

Under conventional magnetic recording, a media substrate of the disk can commonly be formed from aluminum or an aluminum alloy, such as, for example, an aluminum-magnesium alloy. Alternatively, the media substrate can be formed from a glass, such as soda-lime glass, which has a CTE of about 9.0 ppm/° C. For aluminum/aluminum alloy media disks, one or more of the motor hub, disk spacer and disk clamp is typically made of an aluminum alloy, such as ALUMINUM 6061 or Alloy 5052, with or without EN (Electroless Nickel) plating. As such, these components or HDD components-motor hub, disk spacer and disk clamp-typically have a CTE that is about equal in value (or close) to the CTE of the media disks. For glass media disks, the HDD components are typically made from stainless steel (for example, Daido DHS-1 or DHS-1B or stainless steel 400 series) and/or titanium. In some designs, the spacer can be made from glass to match the media disk. However, the relatively more complex geometry of the motor hub and disk clamp make it challenging to form those components out of glass. In addition, glass spacers can be susceptible to scratching and other damage to the media.

More recently, media disks are formed of a lower CTE glass substrate to improve the magnetic performance of the media. The resulting challenge is that such glass material has a CTE value appreciably different than the CTE value of the commonly used materials described above for the HDD components that directly contact the media disks.

In some embodiments, the substrate of the recording disk 18 of the HDD 10 can be formed from a low CTE glass, such as borosilicate glass, aluminosilicate glass or combinations thereof, which results in the disk 18 having a low CTE. Borosilicate glass typically has a CTE ranging from about 3.0 to about 4.0 ppm/° C. (3.0-4.0×10⁻⁶/° C.). Aluminosilicate glass typically has a CTE ranging from about 5.0 to about 6.0 ppm/° C. (5.0-6.0×10⁻⁶/° C.). The specific CTE value of the glass can depend, in part, on the particular glass type or combination, and the relative amounts of the main components in the composition, which can include one or more of silicon dioxide, boric oxide, aluminum oxide or dioxide, at least one alkali oxide and/or alumina. In some embodiments, the substrate for the recording disk 18 can be formed of a borosilicate glass having a CTE around 3.7 ppm/° C. (3.7×10⁻⁶/° C.). In some embodiments, the substrate for the recording disk 18 can be formed of glass materials that result in the recording disk 18 having a CTE from about 2.0 to about 6.0 ppm/° C., or from about 3.0 to about 5.5 ppm/° C.

In some embodiments, the substrate of the recording disk 18 can be formed of even lower CTE glass or ultra-low expansion glass materials, which can have a CTE from about 0 to about 2.0 ppm/° C. (2.0×10⁻⁶/° C.). Such glass media substrates can be, for example, ULE® Glass (Corning Code 7972), which is a titania-silicate glass that can have a CTE of about 1.0 ppm/° C. (1.0×10⁻⁶/° C.) or less. As another example, the substrate of the recording disk 18 can be formed of ZERODUR® Glass-Ceramic, which is a lithium-aluminosilicate glass that can have a CTE of about 1.0 ppm/° C. (1.0×10⁻⁶/° C.) or less. A combination of ULE® glass and ZERODUR® glass-ceramic can be used, and/or other similar glass products having a low or near zero CTE. As such, in some embodiments, the substrate for the recording disk 18 can be formed of glass materials that result in the recording disk 18 having a CTE that is less than or equal to about 2.0 ppm/° C. In some embodiments, the CTE is from about zero to about 2.0 ppm/° C.

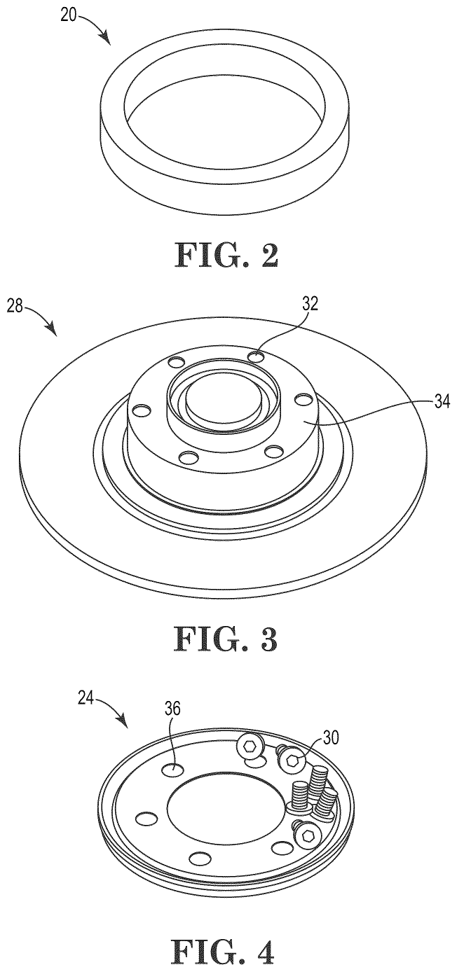

Under the design of the HDD 10 of FIG. 1, each of the disk spacers 20, the motor hub 28, and the disk clamp 24 have direct contact with the media/disks 18. In some embodiments, the HDD 10 uses heat assisted magnetic recording (HAMR). In some embodiments, a glass substrate having a lower CTE is used for the media/disks 18, as described above, to improve the magnetic performance of the disk 18. Performance of the HDD 10 can be improved by forming one or more of the direct contact HDD components 20, 24 and 28 with the iron alloys disclosed herein that have a low CTE that is within an acceptable range of the CTE of the lower CTE glass (such as borosilicate). Each of these direct contact HDD components 20, 24, and 28 are described further below in reference to FIGS. 2-4.

FIG. 2 is a schematic of one of the plurality of disk spacers 20 (also referred to as ring spacers) of FIG. 1. The disk spacer 20 is generally simpler in design than the spindle motor 22 and the disk clamp 24. In some embodiments, the spacer 20 is annular or ring-shaped.

Given its relatively simple design, the disk spacer 20 could be made from glass to match the disk 18. However, if that is the case, the disk spacer 20 can easily become scratched or develop cracks due to hard particles (for example, from a coating used for the spacer). By contrast, if the disk spacer 20 is formed of the iron alloys described herein, there is less of a concern of particles causing scratching or other damage. Moreover, the iron alloy can have good surface conductivity, and little to no electrostatic discharge (ESD) or particle attraction from accumulated surface electrostatic charge, which can happen with surfaces formed from glass or pure plastic.

FIG. 3 is a schematic of the motor hub 28 which can be part of the spindle motor 22 (see FIG. 1). The motor hub 28 can be configured to receive the disks 18 and rotate during operation of the spindle motor 22.

The motor hub 28 includes apertures 32 on an inner top face 34 of the motor hub 28 to enable attachment of the disk clamp 24 to the motor hub to secure the disks 18. Given additional features on the motor hub 28, machinability can be more challenging, relative to forming the disk spacer 20.

FIG. 4 is a schematic of the disk clamp 24. The fasteners 30 are configured to attach the disk clamp 24 to the motor hub 28 via apertures 36 on the disk clamp 24. The disk clamp 24 can include additional features, such as a lip around an outer circumference of the clamp 24, that can make it more challenging to form, relative to the disk spacer 20.

Use of the low expansion/iron alloys described herein to form the direct contact HDD components 20, 24 and 28 results in a low differential between the CTE of the glass and the CTE of the HDD component. For purposes of the present disclosure, the term “low CTE glass” or “lower CTE glass” refers to a glass, such as borosilicate, that has a CTE that is appreciably lower than conventional types of glass, such as soda-lime-silicate glass, used for HDDs.

The low-expansion/iron alloys disclosed herein contain at least two constituents-iron and at least one non-iron metal. The iron alloy or alloy composition can also be described herein as containing an iron constituent and at least one non-iron metal constituent. In other words, the iron alloy can include iron as a first or second primary/active element, and then one or two additional primary/active elements. In some embodiments, the low expansion iron alloy includes iron as the first primary element and nickel as the second primary element, and optionally includes a third primary element, either cobalt or chromium. As such, the iron alloy can include a binary alloy of iron-nickel and ternary alloys of iron-nickel-cobalt and iron-nickel chromium. In some embodiments, the low expansion iron alloy includes cobalt as the first primary element, nickel as the second primary element, and chromium as the third primary element to form a ternary alloy of cobalt-nickel-chromium. For purposes of the present disclosure, such alloy, in which cobalt is at the highest amount relative to nickel and chromium, is still referred to herein as an iron alloy.

In some embodiments, an amount of iron in the low expansion iron alloy composition is from about 30 to about 70 weight percent and an amount of the non-iron metal constituent(s) in the alloy composition is from about 30 to about 70 weight percent. The amount of the non-iron metal(s) can be a summation of the non-iron metal constituents if there is more than one non-iron metal constituent. In some embodiments, the amount of iron in the alloy is from about 30 to about 40 weight percent, from about 40 to about 55 weight percent, or from about 54 to about 70 weight percent. In some embodiments, the amount of the non-iron metal(s) is from about 60 to about 70 weight percent, from about 45 to about 60 weight percent, or from about 30 to about 45 weight percent.

The non-iron metal constituents of the alloy composition can include one or more metals such as nickel, chromium, and cobalt. The specific constituents selected and the percentage of each constituent in the iron alloy, including the percentage of iron, can be tailored to achieve a predetermined target CTE. The target CTE of the iron alloy used to form the HDD component does not have to be equal to the CTE of the low CTE glass to be an effective match of the HDD component and the media substrate. As such, there can be a measurable difference between the target CTE of the iron alloy and the CTE of the low CTE glass—this value is an absolute difference and is referred to herein as ‘delta’ for purposes of the present disclosure. In some embodiments, the delta (or absolute difference/difference in value) is about 3 μm/m/° C. or 3 ppm/° C. or less, about 2 ppm/° C. or less, or about 1 ppm/° C. or less.

In an example in which the media disk or glass media substrate has a CTE equal to 3.7 ppm/° C., the target CTE of the iron alloy is 3.7±3, which equates to a range of 0.7-6.7 ppm/° C. (0.7-6.7×10⁻⁶/° C.). In some embodiments, the delta is about 2 μm/m/° C. or 2 ppm/° C. (2×10⁻⁶/° C.), or less. If the media disk or glass media substrate has a CTE equal to 3.7 ppm/° C., the target CTE of the iron alloy is 3.7±2, which equates to a range of 1.7-5.7 ppm/° C. (1.7-5.7×10⁻⁶/° C.). In some embodiments, the delta is about 1 μm/m/° C. or 1 ppm/° C. (1×10⁻⁶/° C.) or less, and the target CTE of the iron alloy is 3.7±1 or 2.7-4.7 ppm/° C. It is recognized that a CTE of 3.7 ppm/° C. is used as an example and the media disk or glass media substrate can have a CTE of about 4.0 ppm/° C. and the target CTE of the iron alloy, in some embodiments, can be from about 2.0 to about 6.0 ppm. In some embodiments, the media disk or glass media substrate can have a CTE greater than about 4 ppm/° C. or less than about 4.0 ppm/° C., and the target CTE of the iron alloy is adjusted accordingly.

In some embodiments, the glass media substrate is formed of an ultra-low expansion material and the CTE of the media disk or glass media substrate is about 2 ppm/° C. or less. As such, the particular iron alloy composition can be selected based on a target CTE value that may be lower than the target values when the media disk or glass media substrate has a CTE of about 3.7 ppm/° C. as provided above.

In some embodiments, the iron alloy is a binary alloy formed of iron and nickel. An amount of nickel in the binary alloy can range from about 30 to about 45 weight percent, and an amount of iron in the binary alloy can range from about 53 to about 70 weight percent; a CTE of such alloy can be from about 2.0 ppm/° C. to about 6.0 ppm/° C. In some embodiments, the amount of nickel can be from about 34 to about 38 weight percent, and thus the amount of iron can be from about 62 to about 66 weight percent; a CTE of such alloy can be from about 0 to about 2.0 ppm/° C. In some embodiments, the amount of nickel in the iron-nickel alloy is from about 30 to about 34 percent, and the amount of iron is from about 66 to about 70 weight percent. In some embodiments, the amount of nickel is from about 38 or about 45 weight percent and the amount of iron is from about 55 to about 62 weight percent.

An example of an iron-nickel alloy is Invar®, also known as FeNi36 or 64FeNi. Thus, in one example, the iron-nickel alloy is about 36% by weight nickel and about 64% by weight iron. A common grade of Invar® iron-nickel alloy has a CTE of 1.2 ppm/° C.

An example of an iron-nickel alloy is about 42% by weight nickel and about 58% by weight iron. A CTE of such alloy is from about 4.0 to about 4.7 ppm/° C.

The iron alloy compositions disclosed herein (including the binary iron-nickel alloy and the ternary alloys below) can include one or more impurities at low levels. Such impurities can include, but are not limited to, manganese, silicon, copper, aluminum, carbon, zirconium, and sulfur. Generally, the impurities are collectively less than 1 or 2 percent (by weight) of the composition. Thus, the precise amount of iron and/or nickel in the alloy compositions disclosed herein can depend, in part, on the presence of impurities in the composition.

In some embodiments, the iron alloy is a ternary alloy formed of iron, nickel and cobalt (Fe—Ni—Co alloy). An amount of nickel in the Fe—Ni—Co alloy can range from about 25 to about 45 weight percent; an amount of cobalt in the Fe—Ni—Co alloy can range from about 1 to about 25 weight percent, and an amount of iron in the Fe—Ni—Co alloy can range from about 40 to about 70 weight percent. A CTE of the Fe—Ni—Co alloy can range from about 0 to about 6.0 ppm/° C.

In some embodiments, iron is at least 40 weight percent of the Fe—Ni—Co alloy, and the summation of nickel and cobalt is from about 30 to about 60 weight percent. In some embodiments, iron is from about 43 to about 65 weight percent in the Fe—Ni—Co alloy. In some embodiments, nickel is from about 25 to about 36 weight percent in the Fe—Ni—Co alloy. In some embodiments, nickel is from about 27 to about 34 weight percent. In some embodiments, nickel is from about 29 to about 32 percent. In some embodiments, cobalt is from about 4 to about 25 weight percent in the Fe—Ni—Co alloy. In some embodiments, cobalt is from about 15 to about 19 weight percent. In some embodiments, cobalt is from about 4 to about 7 percent.

An example of an Fe—Ni—Co alloy is Kovar®. Thus, in one example, the iron-nickel-cobalt alloy can have about 29% by weight nickel and about 17% by weight cobalt. The remaining amount present in the Fe—Ni—Co alloy is iron, which can be from about 52 to about 54% by weight, depending on the amount of impurities in the composition. A common grade of Kovar® iron-nickel-cobalt alloy has a CTE of 5.0 ppm/° C.

This ternary alloy of iron-nickel-cobalt was designed to have substantially similar thermal expansion characteristics as borosilicate glass, including a nonlinear thermal expansion curve that can be made to match that of glass.

Another example of an iron-nickel-cobalt alloy is Super Invar®, which contains about 32% by weight nickel and about 5% by weight cobalt. Depending on the trace amounts of any additional constituents, the remaining amount of the Fe—Ni—Co alloy is iron at about 62 or 63% by weight. The CTE of a common grade of Super Invar® iron-nickel-cobalt alloy is 0.6 ppm/° C.

As exemplified by the difference in CTE between Kovar® alloy and Super Invar® alloy, the Fe—Ni—Co alloy is sensitive to changes in the amounts of nickel and cobalt in the alloy. A specific composition of the Fe—Ni—Co alloy, in terms of the percentage of nickel and cobalt (and consequently iron), can be adjusted to achieve a targeted CTE for the alloy that is suitable to the CTE of the glass media/substrate. The delta (or CTE differential) between Kovar® alloy and low CTE glass is 1.3 ppm/° C. (5.0-3.7). The delta (or CTE differential) between Super Invar® alloy and low CTE glass is 3.1 ppm/° C. (3.7-0.6). In some embodiments, if a lower delta is desired, a custom Fe—Ni—Co alloy can be formulated such that the CTE of the alloy is closer to 3.7 ppm/° C.

In some embodiments, the iron alloy is a ternary alloy formed of iron, nickel, and chromium (Fe—Ni—Cr alloy). An amount of nickel in the Fe—Ni—Cr alloy can range from about 25 to about 45 weight percent, an amount of chromium in the Fe—Ni—Cr alloy can range from about 1 to about 25 weight percent, and an amount of iron in the Fe—Ni—Cr alloy can range from about 40 to about 70 weight percent. A CTE of the Fe—Ni—Cr alloy can range from about 0 to about 6.0 ppm/° C. In some embodiments, depending on a particular percentage for each of iron, nickel and chromium, the CTE can range from about 0 to about 2.0 ppm/° C.

If price and/or corrosion is a concern, the Fe—Ni—Cr alloy may be well suited for use in forming the HDD components. An amount of relative humidity (RH) in the hard disk drive can depend, in part, on a type of HDD. If the RH is low, corrosion may not be a concern or of minimal concern. For HDDs having higher inner RH in which corrosion may be a concern, the inclusion of chromium instead of cobalt may help with both cost and corrosion.

In some embodiments, the iron alloy is a ternary alloy formed of cobalt, iron, and chromium (Co—Fe—Cr alloy). An amount of cobalt in the Co—Fe—Cr alloy can range from about 45 to about 55 weight percent, an amount of iron in the Co—Fe—Cr alloy can range from about 30 to about 40 weight percent, and an amount of chromium in the Co—Fe—Cr alloy can range from about 5 to about 20 weight percent. A CTE of the Co—Fe—Cr alloy can range from about 0 to about 6.0 ppm/° C. Although the Co—Fe—Cr alloy can be referred to as a cobalt alloy since cobalt is the highest-level constituent, the Co—Fe—Cr alloy is referred to herein as an iron alloy.

In some embodiments, the alloys disclosed herein can include electroless nickel (EN) plating or Zn plating.

The particular iron alloy composition used for forming an HDD component can depend on the particular glass used for the media substrate. As detailed above, in some embodiments, the media substrate can be formed of a glass having a CTE from about 2 to about 6 ppm/° C. In some embodiments, the target CTE of the iron alloy composition can be about 4.0 ppm/° C. such that the CLE of the iron alloy is within ±2 of the CTE of the glass.

In some embodiments, the media substrate can be formed of a glass having a CTE less than about 2 ppm/° C. In some embodiments, the CTE of the glass can range from near zero to about 2.0 ppm/° C. Accordingly, in some embodiments, the target CTE of the iron alloy composition can be within ±1 or ±2 of the CTE of the glass.

Although exemplary compositions are provided herein for a low expansion alloy containing iron and at least one non-iron metal, it is recognized that the low expansion alloy can include additional combinations not specifically described herein.

In some embodiments, at least two of the three direct contact HDD components—the disk spacer 20 (FIG. 2), the motor hub 28 (FIG. 3) and the disk clamp 24 (FIG. 4)—can be formed of an iron alloy. In some embodiments, two of the three HDD components can be formed of the same iron alloy, in which case the third HDD component can be formed of a different iron alloy disclosed herein (relative to the other two components) or another material that is not an iron alloy. In some embodiments, two of the three HDD components can be formed of an iron alloy, but the specific iron alloy can be different for each of the two HDD components. As an example, the disk spacer 20 is formed from an iron-nickel alloy, the motor hub 28 is formed from an iron-nickel-cobalt alloy, and the disk clamp 24 is formed from something other than the iron alloys disclosed herein. In some embodiments, all three HDD components can be formed of an iron alloy, but the specific iron alloy can be different between one or more of the three components. Such differences can include different constituents or the same constituents at different amounts.

In some embodiments, the three HDD components can be formed of the same iron alloy. In that case, all three HDD components have the same CTE value and the particular alloy composition can be tailored based on a desired delta between the CTE of the alloy composition and the CTE of the media substrate. The thermal expansion or contraction of each of the three components would also be at the same level, which can help to minimize the deformation to each other and to the recording disk. Having two or all three components made from the same iron alloy can be beneficial from an efficiency perspective in terms of processing, if two or more components are manufactured by the same supplier. Even if different manufacturers or different material suppliers are used, it can be beneficial to use the same alloy composition or similar alloy composition to minimize the CTE difference.

Machinability can be balanced with CTE in selecting a particular composition of the iron alloy for forming the HDD component. Processing steps or considerations that may be important in forming the HDD component include, but are not limited to, heat treatment, heat dissipation (through lubricants and cutting fluids), and proper selection of machining tools.

Because the motor hub has a relatively complex shape and geometry, the machinability of the selected alloy is given more consideration in determining the iron alloy composition for forming the motor hub.

Both Invar® and Kovar® alloys have a relatively low thermal conductivity (13 and 17 W/mK, respectively), and heat can build up in the material during processing. Both Invar® and Kovar® alloys can be sticky and considered, in some instances, as difficult to cut. As such, appropriate machining tools (including material selection and geometrical design) can be used.

Kovar® alloy can harden quickly and thus cooling can be used during processing. Kovar® alloy can be machined using oil-based lubricants and cutting fluids that are water-soluble. Invar® alloy is soft and ductile by comparison. Invar® alloy may require more precise control during forming, including spinning or stamping. If the composition of a particular grade of Invar® alloy is strictly followed, such precision in composition and manufacturing parameters for the HDD components may make Invar® alloy more expensive, as compared to Kovar® alloy.

As described above, the iron alloys of the present disclosure can be tailored to a target CTE value such that the HDD component has a CTE that adequately matches the CTE of the media substate. The CTE values do not have to be equal. In other words, the CTE of the HDD component can be within an acceptable range based on the CTE of the media substrate. This tailoring includes selecting the alloy composition (i.e. which constituent(s) are used in combination with iron) and then selecting the particular percentage of the iron and non-iron constituents in the alloy. Selection of the particular constituents and their corresponding percentages can also depend on other factors described above, including material cost and machinability.

The description of the disclosure and its applications as set forth herein is illustrative and is not intended to limit the scope of the disclosure. Features of various embodiments may be combined with other embodiments within the contemplation of this disclosure. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the disclosure.

1. A hard disk drive comprising:
a spindle motor having a motor hub;
a plurality of recording disks arranged in a stack and rotatably mounted on the motor hub;
a spacer disposed between a pair of recording disks in the plurality of recording disks; and
a disk clamp configured to attach to the motor hub such that the plurality of recording disks are secured to the motor hub, wherein at least two of the motor hub, the spacer, and the disk clamp are made of an iron alloy, the iron alloy comprising iron and at least one non-iron metal constituent selected from nickel, cobalt and chromium, and the iron alloy having a coefficient of thermal expansion (CTE) less than or equal to about 6.0 ppm/° C.

2. The hard disk drive of claim 1, wherein an amount of iron in the iron alloy is from about 30 to about 70 percent (by weight).

3. The hard disk drive of claim 2, wherein the amount of iron is from about 53 to about 70 percent (by weight).

4. The hard disk drive of claim 1, wherein an amount of nickel in the iron alloy is from about 30 to about 70 percent (by weight).

5. The hard disk drive of claim 4, wherein the amount of nickel in the iron alloy is from about 30 to about 45 percent (by weight).

6. The hard disk drive of claim 1, wherein the iron alloy comprises nickel in an amount ranging from about 25 to about 45 weight percent of the iron alloy, iron at an amount of at least 40 weight percent of the iron alloy, and a third metal constituent selected from cobalt and chromium, wherein an amount of the third metal constituent in the iron alloy is from about 1 to about 25 weight percent.

7. The hard disk drive of claim 1, wherein the iron alloy comprises cobalt, iron, and chromium, an amount of cobalt ranges from about 45 to about 55 weight percent of the iron alloy, an amount of iron ranges from about 30 to about 40 weight percent of the iron alloy, and an amount of chromium ranges from about 5 to about 20 weight percent of the iron alloy.

8. The hard disk drive of claim 1, wherein a substrate of a recording disk in the plurality of recording disks is formed from glass having a coefficient of thermal expansion (CTE) less than or equal to about 6.0 ppm/° C.

9. The hard disk drive of claim 8, wherein a difference in value of a CTE of the iron alloy and the CTE of the glass is less than 2 ppm/° C.

10. The hard disk drive of claim 1, wherein the iron alloy has a CTE less than or equal to about 3.7 ppm/° C.

11. The hard disk drive of claim 1, wherein the iron alloy has a CTE less than or equal to about 2.0 ppm/° C.

12. The hard disk drive of claim 1, wherein each of the motor hub, the spacer and the disk clamp are formed of the iron alloy.

13. A component configured to be positioned in a hard disk drive to directly contact a recording disk, the component formed of at least one of a first ternary alloy of iron-nickel-cobalt and a second ternary alloy of cobalt-iron-chromium, wherein the component is chosen from a motor hub, a spacer, a disk clamp, and combinations thereof.

14. The component of claim 13, wherein a CTE of the component is less than or about equal to 6.0 ppm/° C.

15. The component of claim 13, wherein the first ternary alloy comprises:
iron in an amount ranging from about 40 to about 70 weight percent;
nickel in an amount ranging from about 25 to about 45 weight percent; and
cobalt in an amount ranging from about 1 to about 25 weight percent.

16. The component of claim 13, wherein the second ternary alloy comprises:
cobalt in an amount ranging from about 45 to about 55 weight percent;
iron in an amount ranging from about 30 to about 40 weight percent; and
chromium in an amount ranging from about 5 to about 20 weight percent.

17. A method of assembling a hard disk drive, the method comprising:
providing a spindle motor that attaches to a base of the hard disk drive, the spindle motor including a motor hub;
mounting a plurality of disks onto the motor hub in a stacked configuration, the motor hub configured to be received through an opening of each disk of the plurality of disks to mount the plurality of disks onto the motor hub, and the plurality of disks are configured to rotate with the motor hub;
placing an annular spacer between an adjacent pair of disks in the plurality of disks; and
attaching a disk clamp to the motor hub to secure the plurality of disks within the hard disk drive,
wherein at least two of the motor hub, the annular spacer, and the disk clamp are formed from an iron alloy comprising at least one of nickel, cobalt and chromium, and the iron alloy having a CTE less than or equal to about 6.0 ppm/° C.

18. The method of claim 17, wherein the plurality of disks are formed from a glass media substrate having a CTE less than or equal to about 6.0 ppm/° C.

19. The method of claim 18, wherein the CTE of the glass media substrate is from about 2.0 to about 6.0 ppm/° C.

20. The method of claim 17, wherein the iron alloy has a CTE less than or equal to about 3.7 ppm/° C.
